(19) United States
(12) Patent Application Publication
(10) Pub. No.: US 2022/0298458 A1
(43) Pub. Date: Sep. 22, 2022

(54) Method and apparatus for extracting phenols from a wood barrel

(71) Applicant: Brian T. Bolton, Lawrenceville, GA (US)

(72) Inventor: Brian T. Bolton, Lawrenceville, GA (US)

(73) Assignee: Barrel Integrity Solutions, LLC, Lawrenceville, GA (US)

(21) Appl. No.: 17/207,702

(22) Filed: Mar. 21, 2021

(51) Int. Cl. C12L 11/00; C12G 3/07; C12G 1/00; C12H 1/22; B27K 3/36

(52) U.S. Cl. CPC C12L 11/00; C12G 3/07; C12G 1/00; C12H 1/22; B27K 3/36

(57) ABSTRACT

The present invention relates to a method and apparatus for extracting phenols from a wood barrel whereby one or more of the wood barrels filled with a distilled spirit or wine are placed inside a container to which a gas transfer system is connected. The gas transfer system is provided with a pumping means for removing air from the cavity, filling the cavity with a gas, pressurizing the cavity with the gas, and reducing the pressure of the cavity. Means are provided for controlling the distilled spirit or wine evacuating from and absorbing and impregnating the porous structures of the wood barrel.

### BRIEF SUMMARY OF THE INVENTION

This invention relates to a method and apparatus for extracting phenols from a wood barrel. The invention retains the construct, structure, properties and integrity of a wood barrel. The invention allows for the input, control, adjustment, and monitoring the values of high pressure, low pressure, cycle time, rest time, and number of cycles of the process performed by the apparatus so that the final product may achieve the desirable color, flavor, aroma, taste, and body of a distilled spirit or wine.

By reducing the duration of a barometric high, barometric low, and barometric rest, the Invention reduces a seven year aging period for a standard 53 gallon barrel containing a distilled spirit to 336 days.

By reducing the duration of a barometric high, barometric low, and barometric rest, the Invention reduces a one year aging period for a standard 225 liter barrel containing wine to 48 days.

Under normal aging conditions, at the end of a seven year aging period of a distilled spirit the surface area (sa) to volume (v) is reduced from 33% to 21% due to evaporation. At the end of the invention's 336 day process, evaporation reduces the sa/v to only 32%.

Under normal aging conditions, at the end of a seven year aging period of a distilled spirit the estimated reduction of a barrel's volume due to evaporation goes from 53 gallons in the first year to 35.45 gallons at the end of the 7^{th} year. At the end of the invention's 336 day process the barrel volume reduces from 53 gallons to only 51.35 gallons. The Invention prevents the estimated loss of 15.9 gallons of distilled spirit.

### BACKGROUND OF THE INVENTION

It is well known in the art and widespread for many years to age and mature a distilled spirit or wine in an oak barrel until it possesses the desirable properties (e.g. color, flavor, taste, and aroma). White Oak and European Oak are the preferred species of wood because their cellular structures create an impervious barrier, minimizing leakage of the distilled spirit or wine from the barrel. The species of oak the barrel is constructed from is dependent on the geography and the regulation of the distilled spirit. For example, in the United States The Federal Standards of Identity for Distilled Spirits require bourbon to be aged in new charred white oak barrels. The French Appellation D'origine Controlee require Cognac to be aged in French oak barrels. The Scotch Whiskey Regulations 2009 require Scotch whiskey to be aged in new or used oak casks. There is no regulation for the species of wood used for a wine barrel.

Staves are cut in a desired shape from seasoned oak. The standard dimensions of a stave for a 53 gallon whiskey barrel is 91.44 cm length, and 3.81 cm depth. There are 32 to 35 staves used in the construction of a whiskey barrel. The standard dimensions of a stave for a 225 liter Bordeaux barrel is 4.99 cm length and 22 mm depth. The actual depth the barrel manufacturer planes the stave to is determined by the individual distillery's or winery's specifications. The depth of the stave determines the amount of oxygen transmission and the profile of the distilled spirit or wine. The size of the barrel determines its interior surface area (sa) and volume (v). The interior surface area of the barrel and the volume of distilled spirit or wine have a specific percentage (sa/v). A hole is drilled in one stave for filling, extracting from, and emptying the barrel. During construction, the staves are aligned lengthwise, bent under pressure by a cable, and bound by two steel hoops at the midsection. For a distilled spirit barrel the interior of the entire barrel may be heat treated (e.g. either toasted or charred). Char levels of 1, 2, 3, or 4 are the industry standards. The char levels impart various nuanced flavors to the distilled spirit. The time the barrel is allowed to burn determines the level of char. A wine barrel may be toasted. Toast levels of heavy, medium, or light are the industry standards. The top and bottom of the barrel have a wooden, round, flat head also of oak. The top and bottom of the barrel is bent under pressure to seat the top and bottom head in the notches of the staves. Both ends are bound by steel hoops. The barrel is filled with a distilled spirit or wine and the barrel hole is sealed with a bung.

Barrels are often stored in a warehouse on their side in ricks, on pallets, or standing upright on the ground, which allow for airflow throughout the aging and maturation process in the warehouses. A warehouse may not be climate controlled therefore changes in temperature affect the movement of the distilled spirit or wine into and out of the porous structures of the wood. For a whiskey barrel the demarcation of penetration of the distilled spirit into the stave is commonly referred to as the red line. At various stages of aging the bung may be removed by the distiller or vintner and a small sample of the distilled spirit or wine extracted and analyzed for quality and taste.

The length of time a distilled spirit is to be aged is dependent on the regions' regulations. For example, The Federal Standards of Identity for Distilled Spirits require whiskey to be aged for a minimum of two years. The French Appellation D'origine Controlee require Cognac to be aged for a minimum of two years. The Scotch Whiskey Regulations 2009 require Scotch whiskey to be aged for a minimum of three years. The length of time a wine is to be aged in a barrel is not regulated, however typical aging times is 6 to 30 months, shorter for whites and longer for reds.

In the warehouse the oak barrel during a 12 month period is exposed to an average barometric high and barometric low given the location of the warehouse. An example is a high and low of 100.66 kPa and 95.83 kPa respectively. The differential pressure of the internal pressures of the barrel and the external atmospheric pressures create a pressure gradient force and allow for the distilled spirit or wine to penetrate the wood at the internal surface of the wood barrel, and allow for the air to penetrate the external surface of the wood barrel and evacuate the distilled spirit or wine from the wood.

### DETAILED DESCRIPTION OF THE INVENTION

The present invention relates to a method and apparatus for extracting phenols from a wood barrel. In the United States the “Angels Share” is a common distilled spirits industry euphemistic term used to describe the evaporation that occurs during the aging process of distilled spirits. Evaporation rates vary by distillery or winery and are variable from barrel to barrel. The average evaporation rate per barrel according to some distilleries and wineries is 5% per year. The specific cause of the evaporation is unknown. Due to the evaporation of the distilled spirit over an aging period of 7 years, the surface area to volume ratio (sa/v) decreases from 33% to 25%. The invention reduces the 7 year period of a distilled spirit to 336 days, thereby reducing the evaporation and the sa/v to only 32%. The invention's improvement of sa/v is 78.7%.

The hardness of a species of wood is measured by a Janka scale. The Janka measure is the force required to embed a 11.28 mm diameter steel ball into the wood to a depth of half the balls diameter. The Janka Hardness of White Oak is 6000 N. Therefore, it takes 2128 N to embed a steel ball 2.00 mm into white oak.

Extracting phenols from a wood barrel that contains distilled spirits:

The average density of a distilled spirit is 868.20 kg/m³. The density of steel is 7,849.05 kg/m³. The factor of distilled spirit to steel is 0.111. Penetration of the distilled spirit into the wood layer is, by published research stated to range from 1 mm to 2 mm. It takes 50.12 kPa to drive the distilled spirit 2.0 mm into and out of white oak.

The depth of the charcoal layer is determined by the barrel manufacture's level of char of the barrel (char 1, char 2, char 3, char 4), according to the specifications of the distillery customer. Charcoal layer depths range from 3.2 mm to 6.4 mm. The most common char is #3 with a char depth of 4.8 mm. The density of charcoal is 207.99 kg/m³. The density of white oak is 789.22 kg/m³. The factor of charcoal to white oak is 0.263. A pressure of 31.3 kPa will drive a distilled spirit 4.8 mm into the charcoal layer.

The interior girth of a 53 gallon oak barrel is 59.7 cm diameter. The density of the distilled spirit is 868.20 kg/m³. The pressure of the distilled spirit on the interior wall of the wood barrel is 105.6 kPa. That pressure drives the distilled spirit 4.75 mm into the charcoal layer and 3.0 mm into the wood layer.

The density of oxygen is 1.42 kg/m³. The density of the distilled spirit is 868.20 kg/m³. The factor of oxygen to distilled spirit is 0.002. A pressure of 1.24 kPa will drive oxygen 30.4 mm into the wood, to the point of interchange of the gas and distilled spirit. A pressure of 74.4 kPa will drive the distilled spirit 3.0 mm into the wood, to the point of interchange of the wood and charcoal layer. Reducing the pressure of 50.1 kPa allows the distilled spirit to penetrate 2.0 mm into the wood. An increase of pressure of 50.1 kPa drives the distilled spirit 2.0 mm to the interchange of the wood and charcoal layer.

The method and apparatus' alteration of the pressure of the cavity by 50.1 kPa by a prescribed number of cycles achieves the extraction of the phenols from the wood barrel containing a distilled spirit.

Extracting phenols from a wood barrel that contains wine:

The average density of a wine is 984.97 kg/m³. The density of steel is 7,849.05 kg/m³. The factor of wine to steel is 0.125. Penetration of the wine into the wood layer is, by published research stated to range from 3 mm to 4 mm. It takes 75.6 kPa to drive the wine 4.0 mm into and out of white oak.

The interior girth of a 225 L wine barrel is 69.5 cm diameter. The density of the wine is 984.97 kg/m³. The pressure of the wine on the interior wall of the wood barrel is 104.2 kPa. That pressure drives the wine 5.5 mm into the wood.

The density of oxygen is 1.4 kg/m³. The density of the wine is 984.97 kg/m³. The factor of oxygen to wine is 0.0014. A pressure of 0.45 kPa will drive oxygen 16.5 mm into the wood, the point of interchange of the gas and wine. A pressure of 104.17 kPa will drive the wine 5.5 mm into the wood to the interior side of the stave. A release of 75.56 kPa allows the wine to penetrate 4.0 mm into the wood. A pressure of 75.56 kPa drives the wine 4.0 mm to the interior side of the stave.

The method and apparatus' alteration of the pressure of the cavity by 75.56 kPa by a prescribed number of cycles achieves the extraction of the phenols from the wood barrel containing a wine.

During a 12 month period, according to climatic data there are 1,300 iterations of the barometric pressure reaching a high. The mean time of the duration of the barometric low to barometric high iterations is 01:54:00 (hh:mm:ss). There are 1,300 iterations of the barometric pressure reaching a low. The mean time of the duration of the barometric high to barometric low iterations is 02:00:00. Therefore, there are 1,300 cycles in the 12 month period. The total time of active barometric change is 5,070 hours. There are 8,760 hours in a calendar year. Therefore, there are 8,760−5,070=3,690 hours when there is no barometric activity, a barometric rest. The number of iterations of no barometric change is 11,120. The time of barometric rest 3,690/11,120 cycles is 00:19:54. At this time of barometric rest the distilled spirit attains a state of hydrostatic equilibrium. The total cycle time is 04:48:00.

Atmospheric air has a composition of Nitrogen 78.08%, Oxygen 20.95%. and Other gasses 0.97%. Replacing the atmospheric air in the cavity with oxygen yields an increases the composition of oxygen by 79.05%. This factor improves the oxygenation processes of the wood and the distilled spirit or wine. The oxygenation factor then reduces the barometric low to high cycle time from 01:54:00 to 00:23:53. The oxygenation factor reduces the barometric high to low cycle time from 02:00:00 to 00:25:08. The oxygenation factor reduces the barometric rest from 00:19:54 to 00:04:10. Application of the oxygen factor may reduce the cycle time from 04:48:00 to 00:53:11. Application of the oxygenation factor may reduce the one year equivalent process from 365 days to 48.03 days.

The pressure of the cavity of the container will be gradually increased and gradually decreased. That is to say, the gas will be introduced into and removed from the container at a controlled rate such that the rate at which the pressure is increased is slow enough to allow the distilled spirit or wine in the wood barrel to evacuate from and absorb and impregnate the porous structures of the wood. A rapid decrease or increase in pressure of the cavity may result in the distilled spirit collapsing the critical structural and filtration properties of the charcoal layer of a barrel filled with a distilled spirit. A rapid decrease in pressure of the cavity would cause the distilled spirit or wine to penetrate too deep into the porous structures of the wood barrel imparting undesired qualities of the wood into the distilled spirit or wine. Pressurizing the container at too high a value tends to drive the distilled spirit or wine into the interstices between the staves of the wood barrel, thereby causing the barrel to leak. The Invention's method and apparatus allows for a sufficient rate for the distilled spirit or wine to evacuate from and absorb and impregnate the porous structures of the wood and the distilled spirit or wine penetrating too deep into the wood.

The pressures of the cavity and the internal pressures of the barrel create a differential pressure (delta P). The change of the differential pressures allows the distilled spirit or wine to absorb into and evacuate from the porous structures of the wood. The precise pressure values and rate is subject to a number of variables including but not limited to the size and composition of the wood barrel, the volume of the distilled spirit or wine in the barrel, the temperature of the container, the density of the distilled spirit or wine, and the depth of the charcoal layer. Hence a range in the pressure, pressurizing rate, and the reduction of pressure rate for a given system is necessary.

In order to stabilize and keep the wood barrel from rolling or shifting in the container, the container preferably includes a support frame and serves to hold the wood barrel in place.

One example of a container is a vessel. Other types of containers may be used, consistent with the spirit of the invention.

One example of a standard wood barrel is a 53 gallon whiskey barrel. Other sizes of wood barrels may be used, consistent with the spirit of the invention.

One example of a barrel stave thickness is 22 mm. Other sizes of stave thicknesses may be used, consistent with the spirit of the invention.

The placement and orientation of the wood barrel's top and bottom may be either on the x axis or the y axis of the container. Stated another way, the barrel may be standing on its bottom or be laying on its side.

### SPECIFIC EXAMPLE

In accordance with one specific example of the invention, an apparatus comprising a container having a total volume of 0.078 m³ and a gas transfer system as in FIG. 1. was configured and assembled. The gas reservoir of the gas transfer system had a volume of 0.056 m³. The gas tank of the gas transfer system had of volume of 0.56 m³. The gas transfer system was connected to a port of the container. The wiring of the valves, pressure transducers, and pumps of the gas transfer system were connected to a programmable logic controller (plc), I/O modules, and 24 v DC power supplies connected to AC power, creating the necessary electronic circuitry for the apparatus to operate. The software of the plc provided for the input of the prescribed pressures, pressurization time, rest time, reduction of pressure time, and cycles into the rungs of the ladder logic. The plc read the ladder logic and performed the instructions of the program.

The specific example applied the 79.05% improvement. The example applied a 2% deterioration due to the 2.20 kPa decrement of the internal barrel pressure of a 53 gallon barrel to a 5 gallon barrel. The specific example applied a 52.17% surface area to volume (sa/v) improvement based on a 69% sa/v of a 5 gallon barrel and a 33% sa/v of a 53 gallon barrel.

A commercially available 5 gallon white oak whiskey barrel having an exterior volume of 0.030 m³ was manufactured with a Char #3 and a stave thickness of 38.10 mm. The wood barrel was filled with 5 gallons of commercially available unaged, 125 proof (62.5 abv) distilled spirit that had been processed with a wheated mash bill. The wood barrel was placed on the support frame inside the container and the container was closed with clamps to ensure a pressure tight seal. The cavity of the container was 0.045 m³. The prescribed values of pressures, pressurization time, rest time, reduction of pressure time, and cycles were entered into the rungs of the ladder logic. The plc program was started. The air was expelled from the gas reservoir and replaced with gas. The air was removed from the cavity of the container and replaced with gas. The plc initiated a timer for the prescribed 00:23:54 pressurization time. Gas was slowly introduced to the container such that the pressure slowly built up in the cavity at a rate of 3.17 kPa/min over the 00:23:54 duration of the pressurization time. The prescribed pressure of 75.84 kPa was reached at the prescribed 00:23:54 of pressurization time. The plc initiated a timer for the prescribed 00:02:05 rest time. (A) At the end of the rest time the plc initiated a timer for the prescribed 00:25:08 of release of pressure time. The gas was slowly removed from the container such that the pressure slowly reduced in the cavity at a rate of 1.02 kPa/min over the 00:25:08 duration of the release of pressure time. The prescribed pressure of 50.16 kPa was reached at the prescribed 00:25:08 of release of pressure time. The plc initiated a timer for the prescribed 00:02:05 rest time. At the end of the rest time the plc initiated a timer for the prescribed 00:23:54 of pressure time. Gas was slowly introduced to the container such that the pressure slowly built up in the cavity at a rate of 1.07 kPa/min over the 00:23:54 duration of the pressurization time. The prescribed pressure of 75.84 kPa was reached at the prescribed 00:23:54 of pressurization time. The plc initiated a timer for the prescribed 00:02:05 rest time. The plc repeated the respective steps from (A) above for the prescribed 9,100 cycles over a period of 167 days. Ambient pressure of the container was attained, the clamps were released from the container, and the wood barrel was removed.

### BRIEF DESCRIPTION OF THE VIEW OF THE DRAWINGS

FIG. 1 is a view of a barrel 101 inside a container 102 having a cavity 103. The container having a port 119, a support frame 122 to stabilize the wood barrel 101, and a door 123 with hinges 124 and a handle 125 to allow for the opening and closing and insertion and removal of the wood barrel 101. Connected to the port 119 is a gas transfer system 122 comprising a pressure transducer 106 to measure the pressure of the container 102; a valve 107 connected to port 119 to provide an open or closed path from the container 102; a valve 118 to provide an open or closed path to container 102 connected to the port 119; an air pump 116 connected to valve 118; a valve 115 to expel air from gas reservoir 114 connected to valve 118; an air pump 108 connected to valve 107; a valve 113 connected to air pump 108 to expel air from container 102; a valve 112 connected to air pump 108 to provide an open or closed path from air pump 108; a valve 117 connected to air pump 116 to provide an open or closed path to air pump 116; a valve 110 connected to gas reservoir 114 to provide an open or closed path to or from gas reservoir 114; a pressure transducer 109 to measure the pressure of gas reservoir 114; a gas reservoir 114 connected to valve 110; a valve 104 to provide an open or closed path from gas tank 111; a gas tank 111 connected to valve 104; a gas dryer connected to valve 104 to remove moisture in the gas; a valve 105 attached to gas tank 111 to open or close gas tank.

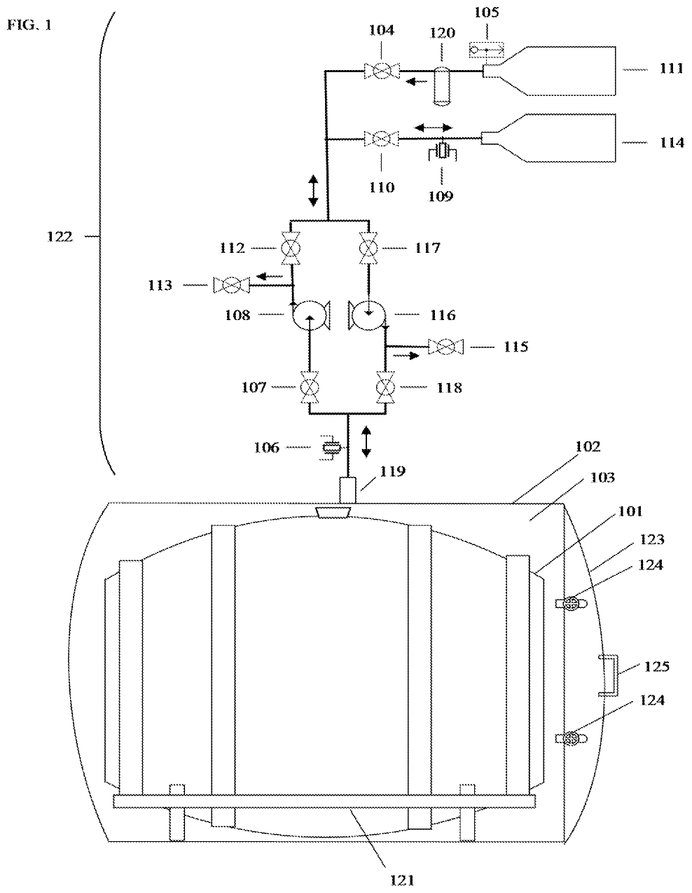

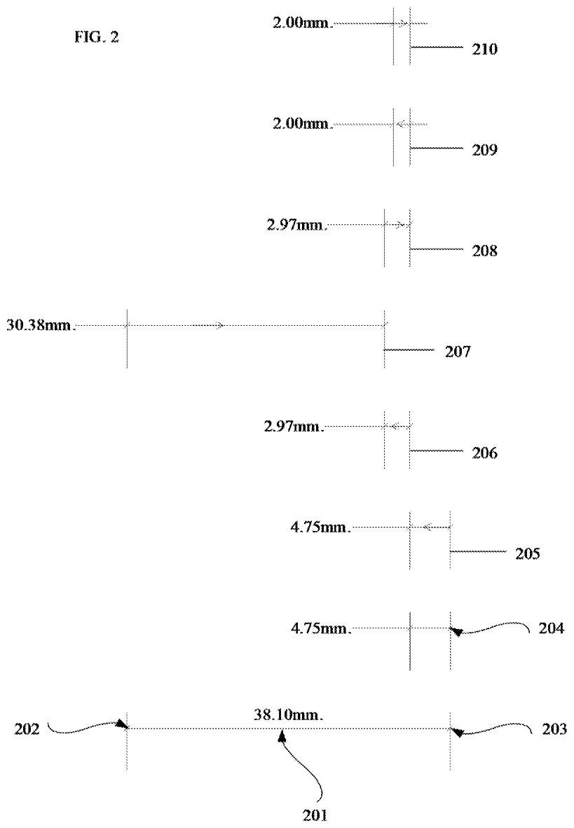

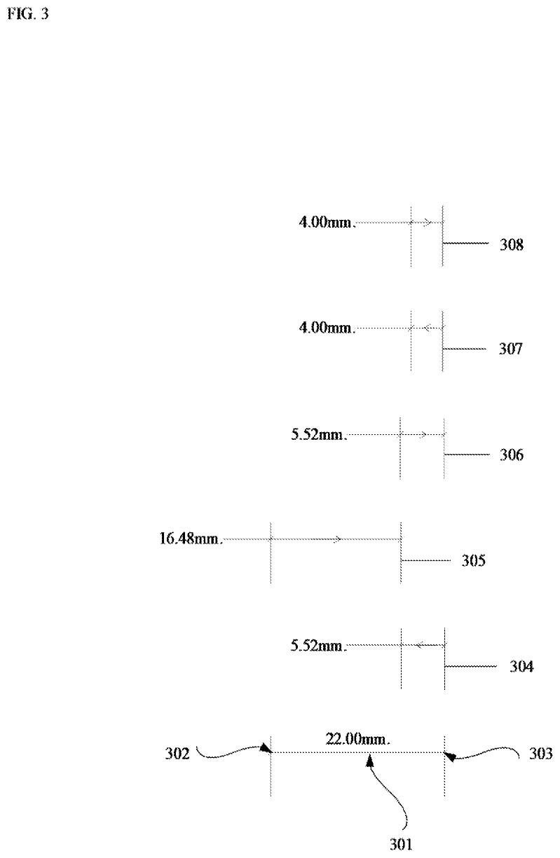

FIG. 2 is a dimensional side view of a stave of a whiskey barrel, its reference points (201-204), and the sequential pressure effects (205-210) in millimeters.
201 The standard 38.10 mm depth of a stave for a 53 gallon whiskey barrel.
202 The exterior side of the stave.
203 The interior side of the stave.
204 The most common char #3 with a charcoal layer depth of 4.75 mm.
205 The pressure of the distilled spirit on the interior wall of the wood barrel is 105.69 kPa. That pressure drives distilled spirit 4.75 mm from the interior side of the stave into the charcoal layer.
206 The pressure of the distilled spirit at the charcoal and wood interface is 74.62 kPa. That pressure drives the distilled spirit 2.97 mm into the wood.
207 A pressurization of 1.22 kPa will drive oxygen 30.38 mm into the wood, the point of interchange of the gas and distilled spirit.
208 A pressurization of 74.62 kPa from the exterior side of the stave will drive the distilled spirit 2.97 mm into the wood to the point of interchange of the wood and charcoal layer.
209 A release of 50.16 kPa allows for the distilled spirit to penetrate back 2.00 mm from the interchange of the wood and charcoal layer into the wood.
210 A pressurization of 50.166 kPa drives the distilled spirit 2.00 mm to the interchange of the wood and charcoal layer.

FIG. 3 is a dimensional side view of a stave of a wine barrel, its reference points (301-303), and the sequential pressure effects (304-308) in decimal inches.
301 The standard 22.00 mm depth of a stave for a wine barrel.
302 The exterior side of the stave.
303 The interior side of the stave.
304 The pressure of the wine on the interior wall of the wood barrel is 104.2 kPa. That pressure drives wine 5.5 mm into the wood.
305 A pressurization of 0.45 kPa will drive the oxygen 16.5 mm from the exterior side of the stave into the wood to the point of interchange of the gas and wine.
306 A pressurization of 104.17 kPa will drive the wine 5.55 mm into the wood to the point of interchange of the wood and the interior side of the stave.
307 A release of 75.56 kPa allows for the distilled spirit to penetrate back 4.00 mm into the wood.
308 A pressurization of 75.56 kPa drives the wine 4.00 mm to the point of interchange of the wood and the interior side of the stave.

The embodiments of the invention in which an exclusive property or privilege is claimed are defined as follows:

1. A method of extracting phenols from a wood barrel comprising the steps of:
a) placing one or more said wood barrels inside a container;
b) enclosing said wood barrel in said container which serves to define a cavity;
c) removing air from said cavity;
d) filling said cavity with gas;
e) pressurizing said cavity with said gas to a prescribed pressure sufficient to urge a distilled spirit or a wine in said wood barrel to evacuate porous structures of said wood barrel;
f) allowing a duration of time sufficient for said distilled spirit or said wine in said wood barrel to evacuate said porous structures of said wood barrel;
g) reducing said pressure of said cavity to a prescribed pressure sufficient to urge said distilled spirit or said wine in said wood barrel to absorb into and impregnate said porous structures of said wood barrel;
h) allowing a duration of time sufficient for said distilled spirit or said wine in said wood barrel to absorb into and impregnate said porous structures of said wood barrel;
i) repeating the method from step e) for a number of prescribed cycles
j) allowing said cavity to attain ambient pressure;
k) opening said container; and
l) removing said wood barrel from said container.

2. A method according to claim 1 whereby said pressurizing said cavity with said gas is at a rate and controlling said rate such that said rate at which said pressure rises in said container during said pressurizing is sufficiently slow as to allow said distilled spirit or said wine in said wood barrel to evacuate said porous structures of said wood barrel.

3. A method according to claim 1 whereby reducing said pressure of said cavity is at a rate and controlling said rate such that said rate at which said pressure is reduced in said cavity is sufficiently slow as to allow said distilled spirit or said wine in said wood barrel to impregnate said porous structures of said wood barrel.

4. An apparatus for extracting said phenols from said wood barrel comprising; said container to place, support, and enclose said wood barrel, a gas transfer system connected to said container, said gas transfer system comprising a framework incorporating a plurality of valves, a plurality of pumps, a gas reservoir, a gas tank, and two pressure transducers, comprising a means for pumping said air from said container, said air from said gas reservoir, said gas to said container, said gas from said container, said gas to said gas reservoir, and said gas from said gas reservoir, and means for transferring said gas from said gas tank to said gas reservoir.
